(19) United States
(12) Patent Application Publication
(10) Pub. No.: US 2014/0028500 A1
(43) Pub. Date: Jan. 30, 2014

(54) Positioning System

(71) Applicant: Yu-Ming Liu, Taichung (TW)

(72) Inventor: Yu-Ming Liu, Taichung (TW)

(21) Appl. No.: 13/561,680

(22) Filed: Jul. 30, 2012

(51) Int. Cl. G01S 3/02

(52) U.S. Cl. 342/463

(57) ABSTRACT

A positioning system includes a signal transmitter and a signal receiver. The signal transmitter is to be attached to a movable object and includes a transmitting module configured to transmit an electromagnetic wave. The signal receiver includes at least three receiving ports arranged on an imaginary plane defined by a first axis and a second axis perpendicular to the first axis, spaced apart from one another in a direction along each of the first and second axes, and configured to receive the electromagnetic wave respectively as received signals. The signal receiver further includes a calculating module for calculating a position of the signal transmitter relative to the signal receiver on the imaginary plane based on the received signals.

### BACKGROUND OF THE INVENTION

1. Field of the Invention

The invention relates to a positioning system, more particularly to a positioning system that is capable of determining position of a movable object in a three-dimensional space.

2. Description of the Related Art

Positioning techniques are used in many electronic products, such as a mouse coupled to a computer. The conventional optical mouse 1 (see FIG. 1) includes a lighting component 11 configured to project light on a surface, a camera 12 configured to capture images of a part of the surface that is illuminated by the lighting component 11 periodically, and a calculating module 13 configured to calculate a displacement of the mouse 1 based on the captured images. However, such optical positioning mechanism is only applicable on a surface.

As shown in FIG. 2, a conventional positioning system 2 that incorporates radio frequency identification (RFID) is capable of determining position of a movable object in a three-dimensional space. The conventional positioning system 2 includes a plurality of RFID readers 21 fixed on respective locations in the three-dimensional space, a RFID tag (e.g., a microchip that has an antenna) 22 attached to a movable object, and a back-end device (not shown) operable to communicate with the RFID readers 21.

When the movable object moves within a read range of the RFID readers 21 in the three-dimensional space, the RFID tag 22 is operable to actively transmit a positioning signal, e.g., a radio wave. The RFID readers are able to receive the positioning signal respectively, such that the back-end device is operable to calculate the position of the RFID tag 22 (i.e., the position of the movable object) by triangulation according to positioning signals received by the RFID readers 21.

Nonetheless, the manufacturing cost of the conventional positioning system 2 is greatly affected by the manufacturing cost of the RFID readers 21, which is relatively high.

### SUMMARY OF THE INVENTION

Therefore, the object of the present invention is to provide a positioning system that is capable of operating in a three-dimensional space while having a relatively lower manufacturing cost.

According to one aspect, a positioning system of the present invention includes a signal transmitter and a signal receiver.

The signal transmitter is to be attached to a movable object and includes a transmitting module. The transmitting module is configured to transmit an electromagnetic wave.

The signal receiver includes at least three receiving ports arranged on an imaginary plane defined by a first axis and a second axis perpendicular to the first axis. The receiving ports are spaced apart from one another in a direction along each of the first and second axes, and are configured to receive the electromagnetic wave separately respectively as received signals. The signal receiver further includes a calculating module configured to calculate a position of the signal transmitter relative to the signal receiver on the imaginary plane based on the received signals received respectively by the receiving ports.

According to another aspect, a positioning system of the present invention includes a signal transmitter and a signal receiver.

The signal transmitter is to be attached to a movable object and includes at least three transmitting ports arranged on an imaginary plane defined by a first axis and a second axis perpendicular to the first axis. The transmitting ports are spaced apart from one another in a direction along each of the first and second axes, and are configured to transmit the electromagnetic wave respectively.

The signal receiver includes a receiving port and a calculating module. The receiving port is configured to receive the electromagnetic waves from the transmitting ports as received signals, respectively. The calculating module is configured to calculate a position of the signal transmitter relative to the signal receiver on the imaginary plane based on the received signals received by the receiving port.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional view of a conventional optical mouse;

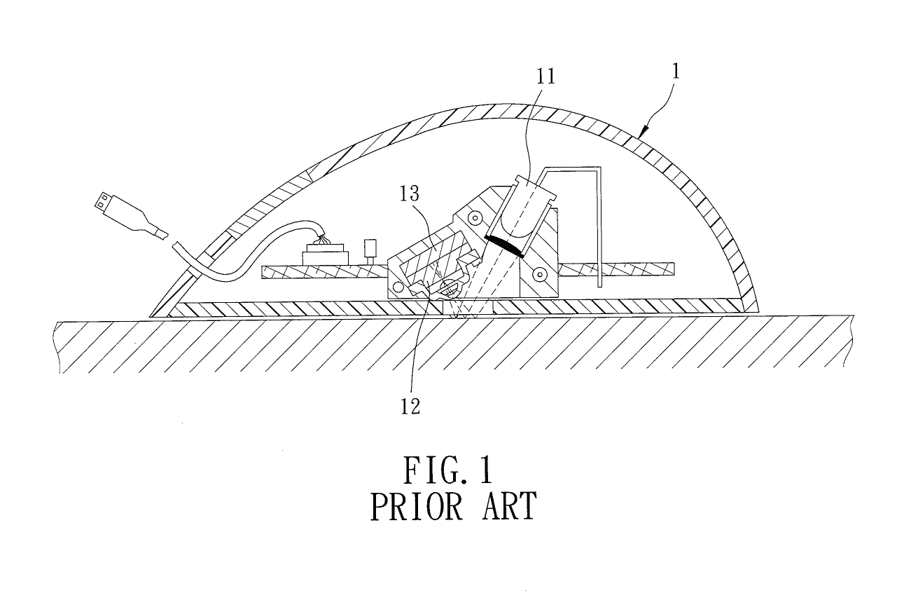

FIG. 2 is a schematic diagram illustrating a conventional positioning system using RFID techniques;

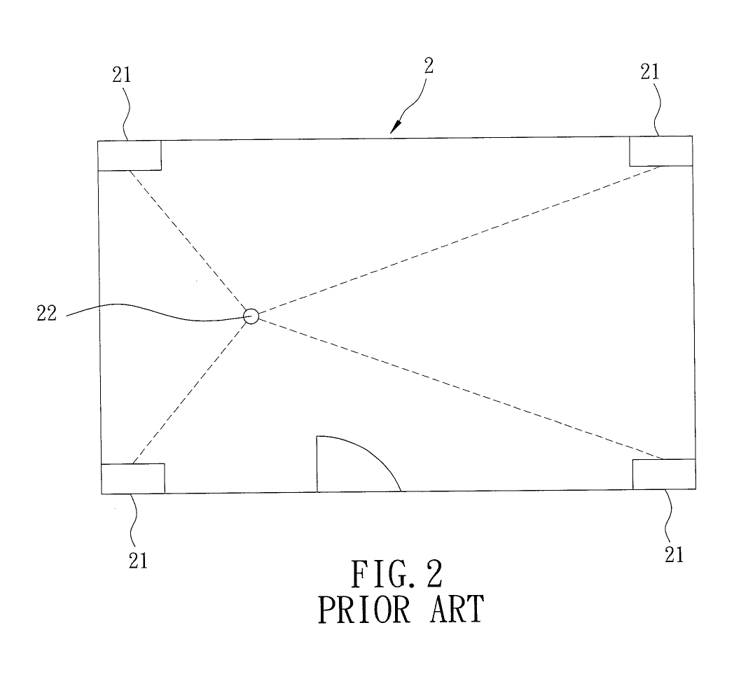

FIG. 3 is a schematic view of a first preferred embodiment of a positioning system according to the invention;

FIG. 4 is a schematic view illustrating another exemplary application of the positioning system of the first preferred embodiment;

FIG. 5 is a schematic block diagram illustrating components of the positioning system of the first preferred embodiment;

FIG. 6 is a schematic view illustrating signal transmission between a signal transmitter and a signal receiver of the positioning system of the first preferred embodiment;

FIG. 7 is a plot illustrating respective waveforms received by receiving ports of the first preferred embodiment;

FIG. 8 is a plot illustrating signal information related to the received signals;

FIG. 9 is a plot similar to FIG. 8, where the receiving ports are arranged in a three-dimensional space;

FIG. 10 is a side view of FIG. 9, where the receiving ports are spaced apart in a vertical direction;

FIG. 11 is a schematic view of a second preferred embodiment of a positioning system according to the invention;

FIG. 12 is a schematic block diagram illustrating components of the positioning system of the second preferred embodiment; and

FIG. 13 is a side view of the second preferred embodiment, where receiving ports of the positioning system are spaced apart in a vertical direction.

### DETAILED DESCRIPTION OF THE PREFERRED EMBODIMENTS

Before the present invention is described in greater detail, it should be noted that like elements are denoted by the same reference numerals throughout the disclosure.

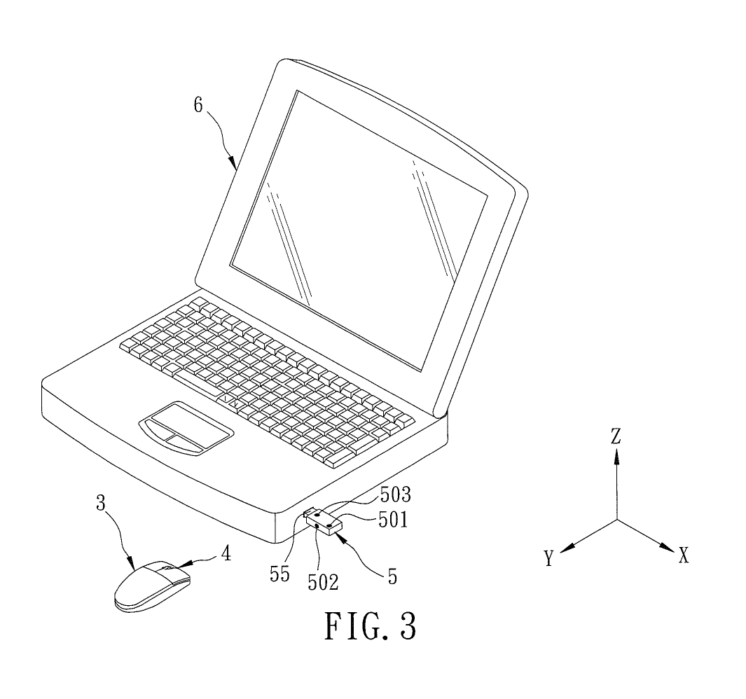

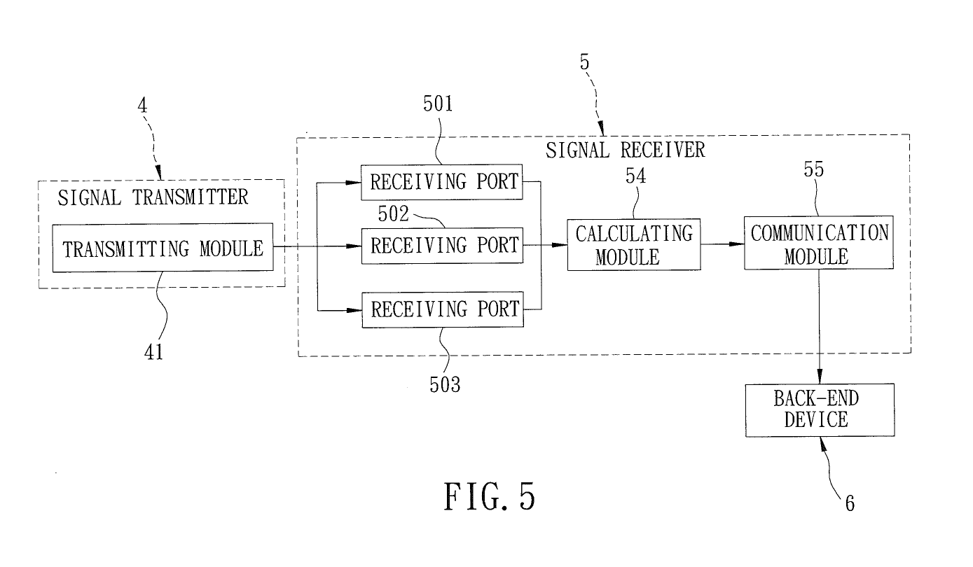

As shown in FIGS. 3 and 5, the first preferred embodiment of a positioning system according to the present invention is for determining position of a movable object 3. The positioning system includes a signal transmitter 4 and a signal receiver 5 that is operable to communicate with a back-end device 6.

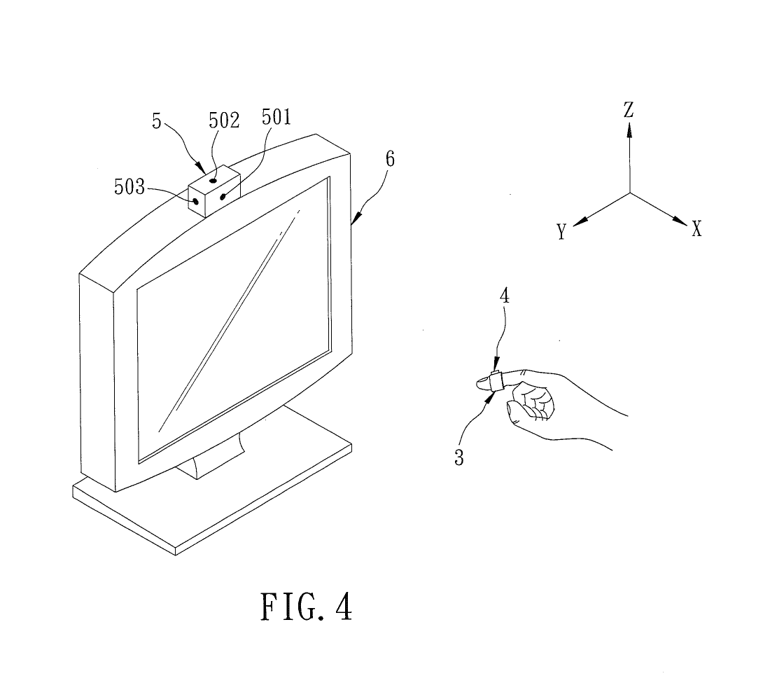

The signal transmitter 4 is attached to the movable object 3, which is a mouse connected to a computer in this embodiment, and which can be other objects such as a finger of a user (see FIG. 4), a remote controller, a glove, etc. The signal transmitter 4 includes a transmitting module 41 configured to transmit an electromagnetic wave. The electromagnetic wave is a sinusoidal wave, and is in a form of one of a radio wave, a microwave and an infrared wave. In this embodiment, the electromagnetic wave is in the form of a radio wave (Wi-Fi compatible) with a frequency of approximately 3 GHz and a wavelength of approximately 10 cm.

In this embodiment, the signal transmitter 5 includes three receiving ports 501-503, a calculating module 54 and a communication module 55. The receiving ports 501-503 are arranged on an imaginary plane defined by a first axis (i.e., the X axis shown in FIG. 3) and a second axis (i.e., the Y axis shown in FIG. 3) perpendicular to the first axis (X), are spaced apart from one another in a direction along each of the first and second axes (X, Y), and are configured to receive the electromagnetic wave respectively as received signals. The calculating module 54 is configured to calculate a position of the signal transmitter 4 (i.e., a position of the movable object 3) relative to the signal receiver 5 on the imaginary plane based on signal information of the received signals received respectively by the receiving ports 501-503. The procedure related to the signal information will be described later.

The communication module 55 is configured to communicate with the back-end device 6 such that the back-end device 6 is operable to indicate the position of the signal transmitter 4. In this embodiment, the communication module 55 is coupled to the back-end device 6, which is selected from a computer, a display and a printer.

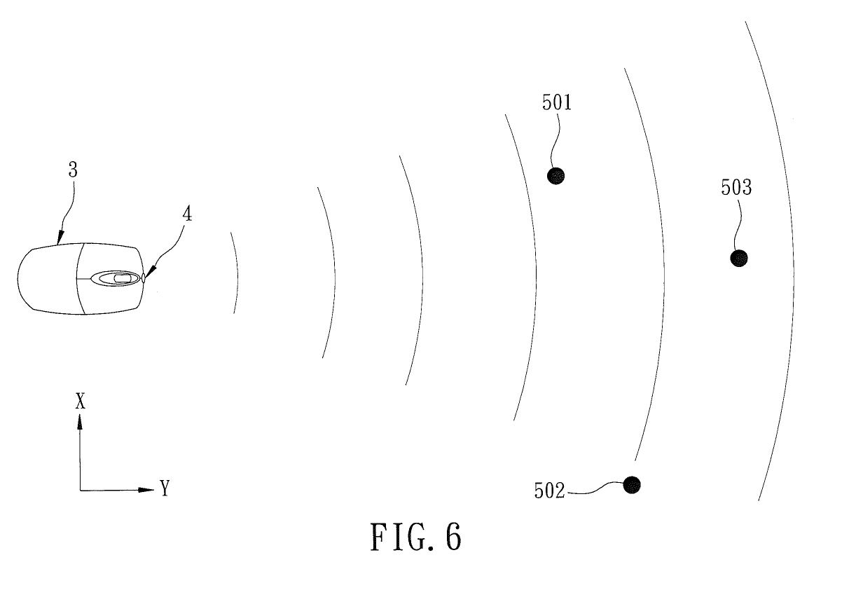

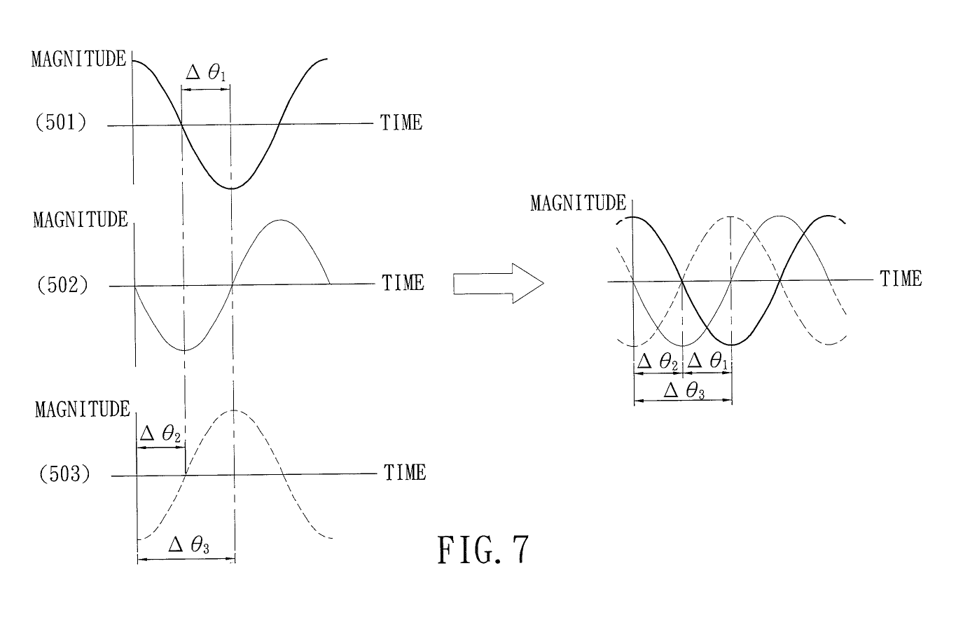

Referring to FIGS. 6 and 7, distances between every two of the receiving ports 501-503 in directions along the first and second axes (X, Y) are known. Therefore, each of the receiving ports 501-503 receives the electromagnetic wave at a respective receipt time with a respective phase and a respective signal strength. As a result, a phase difference exists between each pair of the received signals received by the two of the receiving ports 501-503. That is, as shown in FIG. 7, a first phase difference Δθ₁ exists between the received signals received by the receiving ports 501 and 502, a second phase difference Δθ₂ exists between the received signals received by the receiving ports 502 and 503, and a third phase difference Δθ₃ exists between the received signals received by the receiving ports 501 and 503.

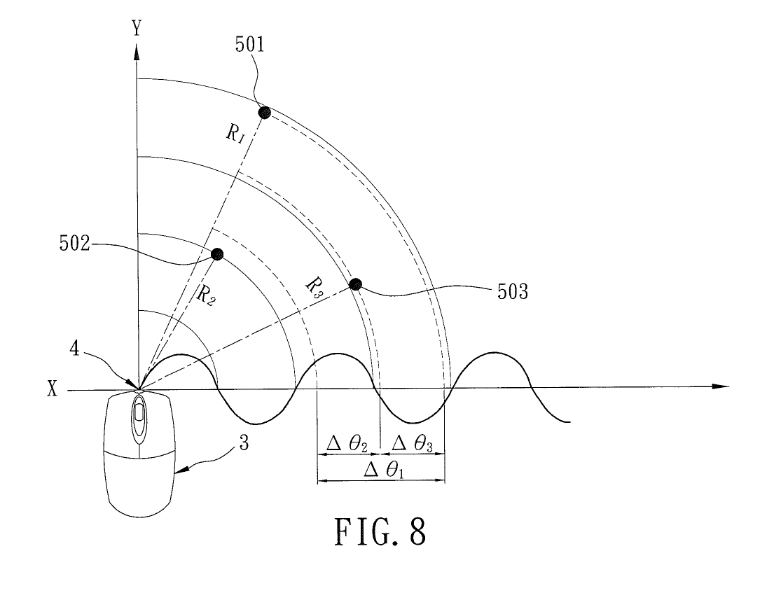

Further referring to FIG. 8, the calculating module 54 is operable to calculate the position of the signal transmitter 4 based on the signal information of the received signals. The signal information includes a time difference among respective receipt times when the receiving ports 501-503 receive the electromagnetic wave, the phase differences Δθ₁-Δθ₃ among the received signals, and respective signal strengths of the received signals. In addition, the calculating module 54 is operable to calculate the position of the signal transmitter 4 further based on respective distance between the signal transmitter 4 and each of the receiving ports 501-503 (indicated by R₁-R₃ in FIG. 7).

Afterward, the communication module 55 is operable to communicate with the back-end device 6, such that the back-end device 6 is operable to indicate the position of the signal transmitter 4 by displaying the coordinates and/or a moving track of the signal transmitter 4.

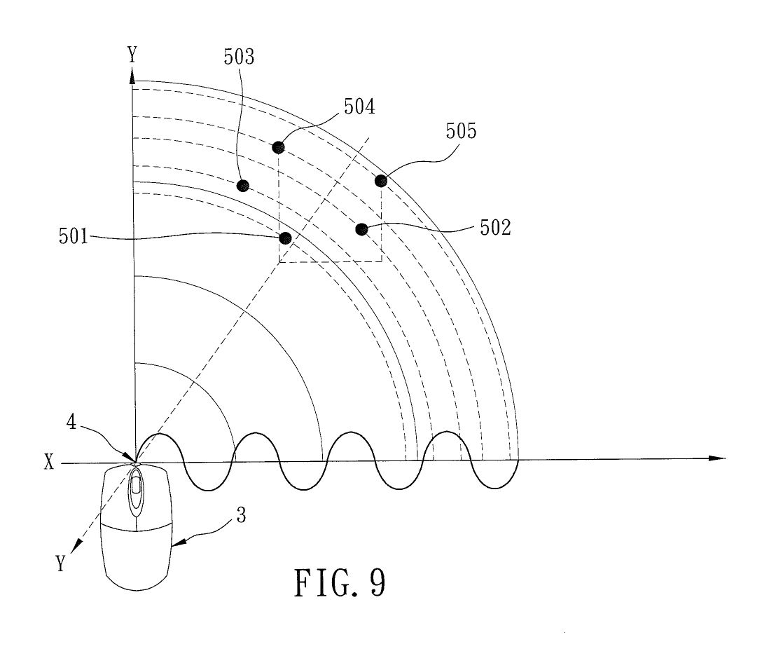

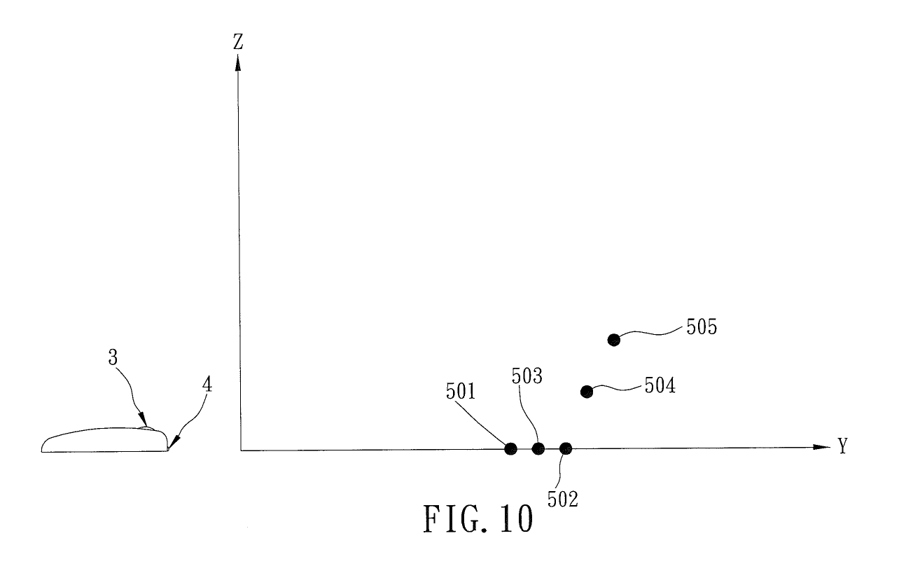

The aforementioned positioning system is capable of calculating the position of the signal transmitter 4 on the imaginary plane. It is noted that the signal receiver 5 of the positioning system of this embodiment may further include at least one receiving port that is not coplanar with the receiving ports 501-503. For example, referring to FIGS. 9 and 10, the signal receiver 5 includes five receiving ports 501-505, where two of the receiving ports 504 and 505 are not coplanar to the receiving ports 501-503. That is, the five receiving ports 501-505 are arranged in a three-dimensional space. Thus, the calculating module 54 is operable to calculate the position of the signal transmitter 4 based on the signal information of the received signals in the three-dimensional space.

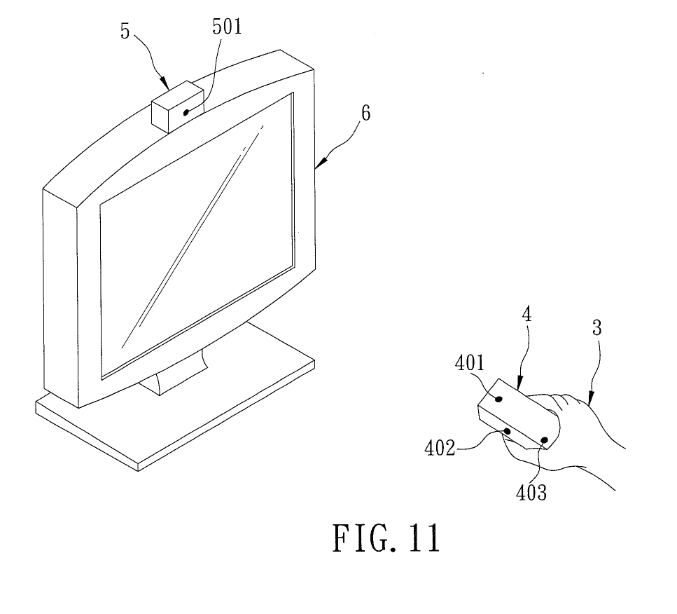

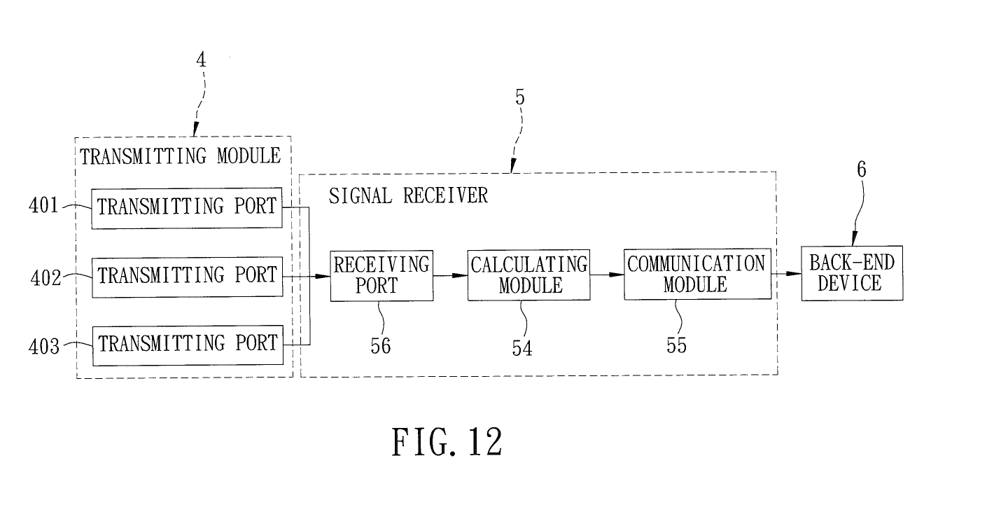

As shown in FIGS. 11 and 12, the second preferred embodiment of the positioning system according to the present invention has a structure similar to that of the first embodiment. In this embodiment, the signal transmitter 4 includes three transmitting ports 401-403 arranged on the imaginary plane, spaced apart from one another in a direction along each of the first and second axes, and configured to transmit the electromagnetic waves respectively. The signal receiver 5 includes only one receiving port 501, the calculating module 54 and the communication module 55.

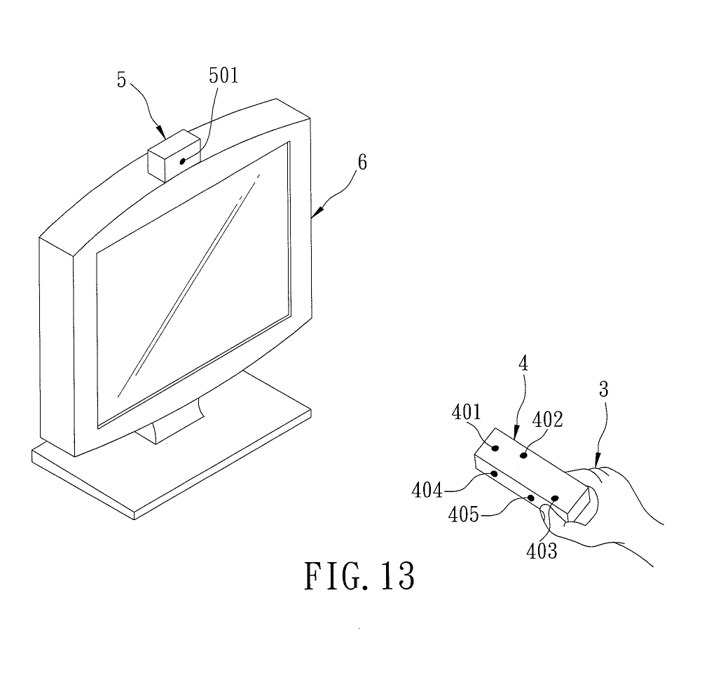

The operations related to the calculating module 54 and the communication module 55 are similar to those described in the first embodiment. Therefore, details thereof are omitted herein for the sake of brevity. It is noted that the positioning system of this embodiment may include at least four of the transmitting ports 401-404 for operating in the three-dimensional space, as shown in FIG. 13.

To sum up, the positioning system of this invention utilizes a plurality of transmitting ports/receiving ports for transmitting/receiving signals, such that the signal information of the received signals vary there among, and the calculating module 54 is operable to calculate the position of the signal transmitter 4 (and the movable object 3) in the three-dimensional space based on the signal information of the received signals. Additionally, when the positioning system is implanted for positioning, the signal transmitter 4 and the signal receiver 5 are relatively inexpensive compared to the conventional RFID devices.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A positioning system, comprising:
a signal transmitter to be attached to a movable object and including a transmitting module configured to transmit an electromagnetic wave; and
a signal receiver including
at least three receiving ports that are arranged on an imaginary plane defined by a first axis and a second axis perpendicular to the first axis, that are spaced apart from one another in a direction along each of the first and second axes, and that are configured to receive the electromagnetic wave respectively as received signals, and
a calculating module configured to calculate a position of said signal transmitter relative to said signal receiver on the imaginary plane based on the received signals received respectively by said receiving ports.

2. The positioning system as claimed in claim 1, wherein the electromagnetic wave is a sinusoidal wave, and said calculating module is configured to calculate the position of said signal transmitter based on signal information of the received signals, the signal information including at least one of:
a time difference among respective receipt times when said receiving ports receive the electromagnetic wave;
a phase difference among the received signals; and
respective signal strengths of the received signals.

3. The positioning system as claimed in claim 1, wherein said signal receiver further includes a communication module that is configured to communicate with a back-end device such that the back-end device is operable to indicate the position of said signal transmitter.

4. The positioning system as claimed in claim 3, wherein said communication module is configured to communicate with the back-end device that is selected from a computer, a display and a printer.

5. The positioning system as claimed in claim 1, wherein the electromagnetic wave is a sinusoidal wave, and is in a form of one of a radio wave, a microwave and an infrared wave.

6. The positioning system as claimed in claim 1, wherein:
said signal receiver includes at least four of said receiving ports that are arranged in a three-dimensional space defined by the first axis, the second axis and a third axis which are perpendicular to one another, and are spaced apart from one another in a direction along each of the first, second and third axes; and
said calculating module is configured to calculate the position of said signal transmitter relative to said signal receiver in the three-dimensional space based on the received signals respectively received by said receiving ports.

7. The positioning system as claimed in claim 6, wherein the electromagnetic wave is a sinusoidal wave, and said calculating module is configured to calculate the position of said signal transmitter based on signal information of the received signals, the signal information including at least one of:
a time difference among respective receipt times when said receiving ports receive the electromagnetic wave;
a phase difference among the received signals; and
respective signal strengths of the received signals.

8. A positioning system, comprising:
a signal transmitter to be attached to a movable object and including at least three transmitting ports that are arranged on an imaginary plane defined by a first axis and a second axis perpendicular to the first axis, that are spaced apart from one another in a direction along each of the first and second axes, and that are configured to transmit the electromagnetic wave respectively; and
a signal receiver including
a receiving port configured to receive the electromagnetic waves from said transmitting ports as received signals, respectively, and
a calculating module configured to calculate a position of said signal transmitter relative to said signal receiver on the imaginary plane based on the received signals received by said receiving port.

9. The positioning system as claimed in claim 8, wherein the electromagnetic wave is a sinusoidal wave, and said calculating module is configured to calculate the position of said signal transmitter based on signal information of the received signals, the signal information including at least one of :
a time difference among respective receipt times when said receiving port receives the electromagnetic waves, respectively;
a phase difference among the received signals; and
respective signal strengths of the received signals.

10. The positioning system as claimed in claim 8, wherein said signal receiver further includes a communication module that is configured to communicate with a back-end device such that the back-end device is operable to indicate the position of said signal transmitter.

11. The positioning system as claimed in claim 10, wherein said communication module is configured to communicate with the back-end device that is selected from a computer, a display and a printer.

12. The positioning system as claimed in claim 8, wherein the electromagnetic wave is a sinusoidal wave, and is in a form of one of a radio wave, a microwave and an infrared wave.

13. The positioning system as claimed in claim 8, wherein:
said signal transmitter includes at least four of said transmitting ports that are arranged in a three-dimensional space defined by the first axis, the second axis and a third axis which are perpendicular to one another, and are spaced apart from one another in a direction along each of the first, second and third axes; and
said calculating module is configured to calculate the position of said signal transmitter relative to said signal receiver in the three-dimensional space based on the received signals received by said receiving port.

14. The positioning system as claimed in claim 13, wherein the electromagnetic wave is a sinusoidal wave, and said calculating module is configured to calculate the position of said signal transmitter based on signal information of the received signals, the signal information including at least one of :
a time difference among respective receipt times when said receiving port receives the electromagnetic waves, respectively;
a phase difference among the received signals; and
respective signal strengths of the received signals.
